(19) United States
(12) Patent Application Publication
(10) Pub. No.: US 2012/0011127 A1
(43) Pub. Date: Jan. 12, 2012

(54) DATABASE MANAGEMENT METHOD AND DATABASE SERVER SYSTEM USING THE SAME

(75) Inventor: Seong-hoon KIM, Suwon-si (KR)

(73) Assignee: Samsung Electronics Co., Ltd, Suwon-si (KR)

(21) Appl. No.: 13/176,849

(22) Filed: Jul. 6, 2011

(30) Foreign Application Priority Data
Jul. 6, 2010 (KR) 10-2010-0064879

(51) Int. Cl. G06F 17/30

(52) U.S. Cl. 707/743; 707/736; 707/E17.083; 707/E17.075

(57) ABSTRACT

A method and apparatus to manage a database in which a data file and an index file are efficiently disposed include generating a table space in such a way that a region of a database in which data in a table form is stored is allocated to a first storage device, and a region of the database in which index information used to search for the data is stored is allocated to a second storage device, storing the data in table form in the first storage device and the index information in the second storage device according to the table space, and storing the data in the database or searching the database according to an input query.

### CROSS-REFERENCE TO RELATED APPLICATIONS

This application claims priority under 35 U.S.C. §119 from Korean Patent Application No. 10-2010-0064879, filed on Jul. 6, 2010, in the Korean Intellectual Property Office, the disclosure of which is incorporated herein in its entirety by reference.

### BACKGROUND OF THE INVENTION

1. Field of the Invention

The present inventive concept relates to a database management method and apparatus, and more particularly, to a method and apparatus to manage a database in which a data file and an index file are efficiently disposed.

2. Description of the Related Art

A database server system structuralizes data, stores the data in a storage device, searches for the data stored in the storage device, and outputs the searched data. Research and effort have been performed to improve data search performance of the database server system and to reduce costs incurred in building the database server system has.

### SUMMARY OF THE INVENTION

The inventive concept provides a method of managing a database in which a data file and an index file are efficiently disposed, thereby improving a database inquiry speed and storage building costs.

The inventive concept provides a database server system by using a method of managing a database in which a data file and an index file are efficiently disposed, thereby improving a database inquiry speed and storage building costs.

The inventive concept provides a computer readable recording medium storing a program to execute a method of managing a database in which a data file and an index file are efficiently disposed, thereby improving a database inquiry speed and storage building costs.

Additional aspects and advantages of the present general inventive concept will be set forth in part in the description which follows and, in part, will be obvious from the description, or may be learned by practice of the general inventive concept.

According to features and utilities of the inventive concept, there is provided a database management method including: generating a table space in such a way that a region of a database in which data in table form is stored is allocated to a first storage device, and a region of the database in which index information used to search for the data is stored is allocated to a second storage device; storing the data in a table form in the first storage device and the index information in the second storage device according to the table space; and storing the data in the database or searching the database according to an input query.

The first storage device and the second storage device may be set to have different storage methods.

The first storage device may be set to have a faster random access speed than that of the second storage device.

The first storage device may include a solid state drive (SSD), and the second storage device comprises a disk drive.

The searching of the database may include: when an index scanning method is used to search for the data, finding a physical position of the first storage device in which desired data is stored by using the index information stored in the second storage device; and reading the desired data stored in the found physical position of the first storage device.

The physical position of the first storage device may be found by searching for the index information stored in the second storage device that is identical to a query condition and obtaining a row ID of a table in which the desire data is positioned.

The searching of the database may include: when a full table scanning method is used to search for the data, finding a physical position of the first storage device in which the desired data is stored by entirely searching a selected table; and reading the desired data stored in the found physical position of the first storage device.

The storing of the data in the database may include: generating the index information used to search for the data in table form to be stored; storing the data in table form in the first storage device and the index information in the second storage device.

The index information may include information used to determine a data access sequence by using a single column or a plurality of columns of the table.

The first storage device and the second storage device may be integrated into a virtual single storage device to allocate logic block addresses (LBAs).

According to features and utilities of the inventive concept, there is provided a database server system including: a database having a plurality of storage devices having different storage methods; and a database management system for managing the database by which data in table form is stored in a first storage device of the plurality of storage devices and index information used to search for the data is stored in a second storage device of the plurality of storage devices.

The database management system may include: a table/index managing unit to generate a table space in such a way that a region of the database in which the data in table form is stored is allocated to the first storage device and a region of the database in which the index information used to search for the data is stored is allocated to the second storage device, and to generate a table and an index in the table space; a query analyzing unit to analyze a received query and to determine a request to be executed; and a query executing unit to execute the request determined by the query analyzing unit.

The database management system, when an index scanning method is requested to search for the data, may find a physical position of the first storage device in which desired data is stored by using the index information stored in the second storage device, and read the desired data stored in the found physical position of the first storage device.

The database management system, when a full table scanning method is requested to search for the data, may find a physical position of the first storage device in which the desired data is stored by entirely searching for a selected table, and read the desired data stored in the found physical position of the first storage device.

According to features and utilities of the inventive concept, there is provided a database system to be connected to an external database management system, the database system including a first storage device connected to the external database management system and having a first storage method to store data in a table form, and a second storage device connected to the external database management system and having a second storage method different from the first storage method to store an index regarding positions of the data stored in the first storage device.

The first storage device may be an SSD, the second storage device may be an HDD, and the first storage device and the second storage device may be independently operable with respect to the external database management system.

The first storage device and the second storage device may be formed as a single storage device to allocate LBAs, the first storage device may be allocated with low LBAs of the LBAs and the second storage device may be allocated with high LBAs of the LBAs, and the low LBAs and the high LBAs may be sequential.

According to features and utilities of the inventive concept, there is provided a database server system including a database management system connected to a first storage device of a database having a first storage method and a second storage device of the database having a second storage method, to manage the first storage device of the database to store data in a table form, and to manage the second storage device of the database to store index information regarding positions of the data stored in the first storage device to be used to search for the data.

The database manage system may receive a query, read the index information from the second storage device, and read the data from the second storage device according to the read index information.

According to features and utilities of the inventive concept, there is provided a database server system including a database having a first storage device to store data in a table form, and a second storage device to store an index regarding positions of the data stored in the first storage device, and a database management system connected to the first storage device and the second storage device to manage the first storage device and the second storage device of the database by which the data in the table form is stored and index information regarding the positions of the data stored in the first storage device to be used to search for the data.

The first storage device and the second storage device may be separate from each other, and independently communicate with the database management system, and the first storage device and the second storage device may store the data and index information which are related to each other.

The database management system may read the index information from the second storage device, and then read the data from the first storage device according to the read index information of the second storage device according to a mode when a query corresponds to the stored index information. The database management system may read the data from the first storage device in another mode when the query does not correspond to the stored index information.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of a part of a database server system according to an exemplary embodiment of the present inventive concept;

FIG. 2 is a detailed block diagram of the database server system of FIG. 1;

FIG. 3 is a schematic diagram of a method of allocating logic block addresses (LBAs) of a database of a database server system, according to an exemplary embodiment of the present inventive concept;

FIG. 4 is a schematic diagram of a method of allocating LBAs of a solid state drive (SSD) of a database server system, according to an exemplary embodiment of the present inventive concept;

FIG. 5 is a schematic diagram of a method of allocating LBAs of a hard disk drive (HDD) of a database server system, according to an exemplary embodiment of the present inventive concept;

FIG. 6 is a flowchart of a database management method according to an exemplary embodiment of the present inventive concept;

FIG. 7 is a flowchart of a process of storing data included in a database management method, according to an exemplary embodiment of the present inventive concept;

FIG. 8 is a flowchart of a process of searching for data included in a database management method, according to an exemplary embodiment of the present inventive concept;

FIG. 9 is a schematic diagram illustrating a method of searching for data in a database server system by using an index scanning method, according to an exemplary embodiment of the present inventive concept;

FIG. 10 is a schematic diagram illustrating a method of searching for data in a database server system by using an index scanning method, according to another exemplary embodiment of the present inventive concept;

FIG. 11 is a graph of a test result of the number of data blocks read to search for data regarding a query for each case for a database including an SSD and an HDD in a database server system according to an exemplary embodiment of the present inventive concept; and

FIG. 12 is a graph of a test result of data search times regarding a query for each case for a database including an SSD and an HDD in a database server system according to an exemplary embodiment of the present inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

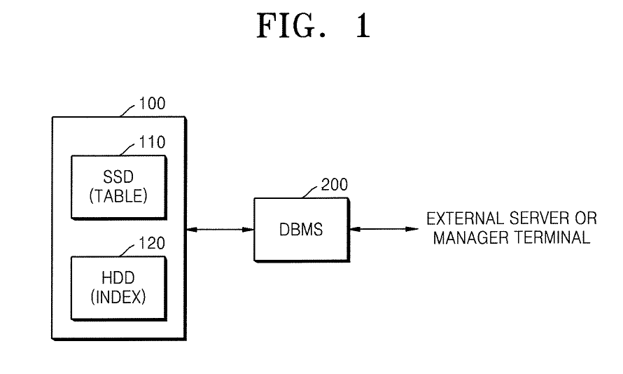

FIG. 1 is a block diagram of a part of a database server system according to an exemplary embodiment of the present inventive concept.

Referring to FIG. 1, the database server system of the present embodiment of the inventive concept includes a database 100 and a database management system (DBMS) 200.

The DBMS 200 generates a table space used to separately allocate a storage space in which data is stored and another storage space in which index information is stored, and performs a process of creating a table and an index in the table space. Here, the table corresponds to the storage space, and the index corresponds to the another storage space.

The DBMS 200 further determines a request to be executed by analyzing a query received from an external server or a manager terminal, and performs a function of managing the database 100, such as renewing or deleting the data stored in the database 100 or storing additional data in the database 100, by executing the request. An example of the query used in the DBMS 200 is structured query language (SQL), etc.

The database 100 may include a plurality of storage devices that use different information storage methods, i.e. a solid state drive (SSD) 110 and a hard disk drive (HDD) 120. The SSD 110 may be referred to as a solid state disk. The storage devices may have different structures, mechanisms, or methods to store, delete, or read data.

The SSD 110 may have a very fast I/O speed and an excellent random access characteristic, whereas the HDD 120 has a slow data access speed since the HDD 120 includes a disk to store data and a mechanical device to read and write the data from and on the disk. Meanwhile, the HDD 120 may have a low cost per unit bit and an excellent sequential access characteristic.

Therefore, when the database 100 includes the SSD 110 only, the database 10 may have a fast data access speed, and the performance of the DBMS 200 may be improved. However, in this case, costs incurred to build the DBMS 200 may increase.

When the database 100 includes the HDD 120 only, the database 100 can reduce costs incurred to build the DBMS 200. However, in this case, a data access speed of the database 100 may be slow, and the performance of the DBMS 200 may not be improved, compared to the performance of the SSD 110.

Here, the database 100 may be referred to as a data storage system having a plurality of data storage spaces so that data can be stored, deleted, modified, read, retrieved, etc. “Database” may be referred to as “data storage” functioning as a database.

The present inventive concept provides a database management method of achieving the maximum performance of the DBMS 200 at a relatively low cost by using the database 100 including the different storage devices having different storage methods.

Information stored in the database 100 may be classified into a data file and an index file. The data file is a set of data in a table form. The index file is a set of data regarding positions of data by using a single column or a plurality of columns of a table corresponding to the stored data file in the table form. The table is a basic structure used to store the data. A single table may include one or more records each including one or more columns. Here, the records may indicate rows.

The SSD 110 and HDD 120 may have different memory structures. For example, the SSD 110 may have a memory structure formed, as a plural dimensional memory spaces, for example, with a two dimensional array, a three dimensional, or plural arrays of memory units to store data, and the HDD 120 may have a different memory structure formed with one or more disks to store data. The memory structure may be represented by column, row, etc, for example. The data can be stored in a table form at positions corresponding to the table.

The size of the index file stored in the database 100 may be different according to the structure of the table or columns included in the index file. However, the size or amount of the index file may be more than 50% of the total storage quantity of the database 100.

The database server system uses two data search methods. If the DBMS 200 receives a query, the DBMS 200 analyzes the query, determines a request to be executed according to the analyzed query, generates a variety of plans according to the request by using object statistics and system statistics information, selects one having a minimum cost from the corresponding costs of the plans, and executes the request regarding the query. In this regard, a full table scanning method and an index scanning method may be used to obtain data from a table.

The full table scanning method of directly searching the entire table may be used when there is no index identical to the condition of a data search query. It is possible that when there is an index similar thereto, it is determined that it is faster to search for desired data from the entire table according to the full table scanning method.

The index scanning method includes an operation of searching for an index identical to the condition of a query, an operation of obtaining a row identifier (ID) of a table indicating a physical position where the desired data is stored, and an operation of finding the desired data from the table by using the row ID.

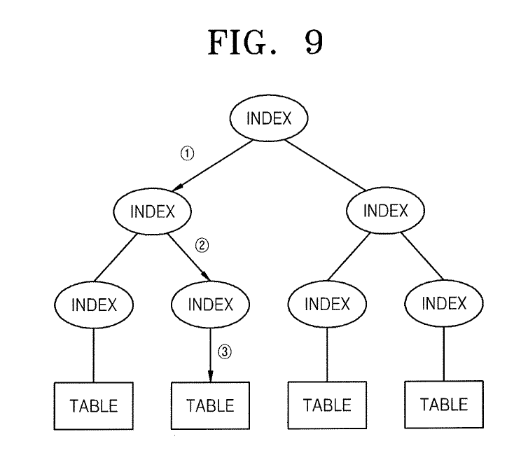

A method of searching for data in a database server system by using an index scanning method will now be described with reference to FIG. 9.

A row ID of a table including desired data is found through a path, such as 1→2, according to index information from an index region based on the search condition of the desired data. The desired data is searched in a physical region of the table by using the row ID in a path 3.

Times taken to perform processes 1 and 2 may be different according to a depth of an index or other conditions, and the times taken to perform processes 1 and 2 may not significantly affect a data search time. However, the time taken to perform a process 3 may correspond to most of the data search time.

In view of the characteristics stated above, the present inventive concept provides the database management method of storing data in a table form in a storage device having a relatively fast random access speed among a plurality of storage devices that use different information storage methods and that are included in the database 100 to separately store the data and index information, and storing the index information in another storage device having a relatively slow access speed among the plurality of storage devices.

According to an embodiment of the present inventive concept, the database 100 including the SSD 110 and the HDD 120 is managed in such a way that the data in a table form is stored in the SSD 110, and the index information is stored in the HDD 120.

Such management of the database 100 reduces the time taken to perform the process 3 of FIG. 9, thereby improving the performance of the database server system.

Although the database 100 includes the SSD 110 and the HDD 120 in the present embodiment of the inventive concept, the present inventive concept is not limited thereto. It is possible that the database 100 may include various storage devices having different information storage methods.

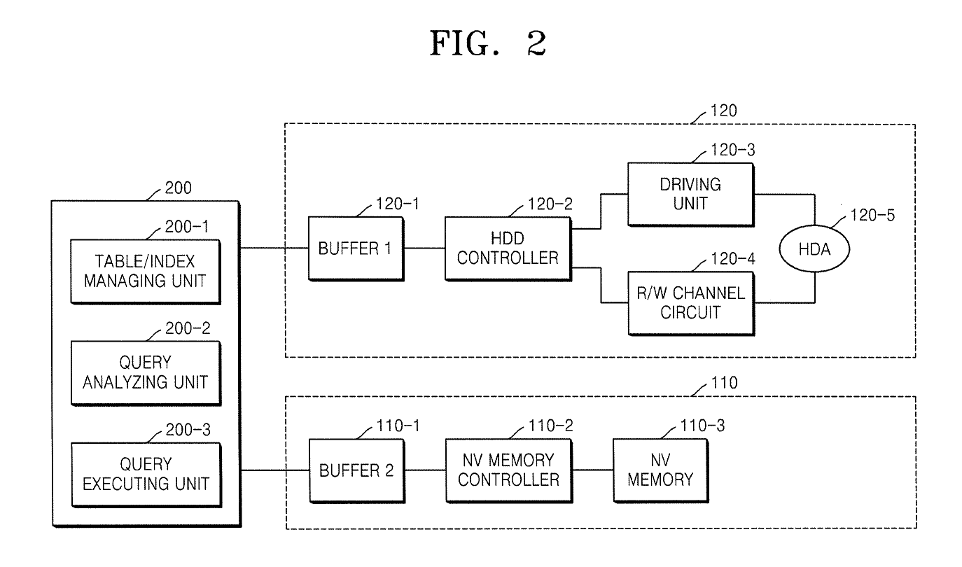

An operation of the database server system using the method of managing the database 100 stated above will now be described with reference to FIG. 2.

FIG. 2 is a detailed block diagram of the database server system of FIG. 1.

Referring to FIG. 2, the database server system of the present embodiment of the inventive concept includes the database 100 and the DBMS 200.

The database 100 includes the SSD 110 and the HDD 120. The HDD 120 includes a buffer 1 120-1, a HDD controller 120-2, a driving unit 120-3, a read/write (R/W) channel circuit 120-4, and a head disk assembly (HDA) 120-5. The SSD 110 includes a buffer 2 110-1, a non-volatile (NV) memory controller 110-2 and an NV memory 110-3. The NV memory 110-3 is a non-volatile semiconductor memory and may be realized as a flash memory, a phase change random access memory (PRAM), a ferroelectric RAM (FRAM), a magnetic RAM (MRAM), and the like.

The DBMS 200 includes a table/index managing unit 200-1, a query analyzing unit 200-2, and a query executing unit 200-3.

The table/index managing unit 200-1 generates a table space that can be used to allocate a region in which data in table form is stored in the SSD 110 and also used to allocate a region in which index information used to search for data is stored in the HDD 120, and generates a table and an index in the table space.

More specifically, the table/index managing unit 200-1 allocates a physical storage space of the SSD 110 to store the data in a table form and a physical storage space of the HDD 120 to store the index information. The table/index managing unit 200-1 further generates tables designed by a database manager thereof and stores the tables in the physical storage space of the SSD 110. The table/index managing unit 200-1 further generates various pieces of index information that can be used to determine a data access sequence by using a single column or a plurality of columns of a table corresponding to the stored data in the table form and stores the index information in the physical storage space of the HDD 120.

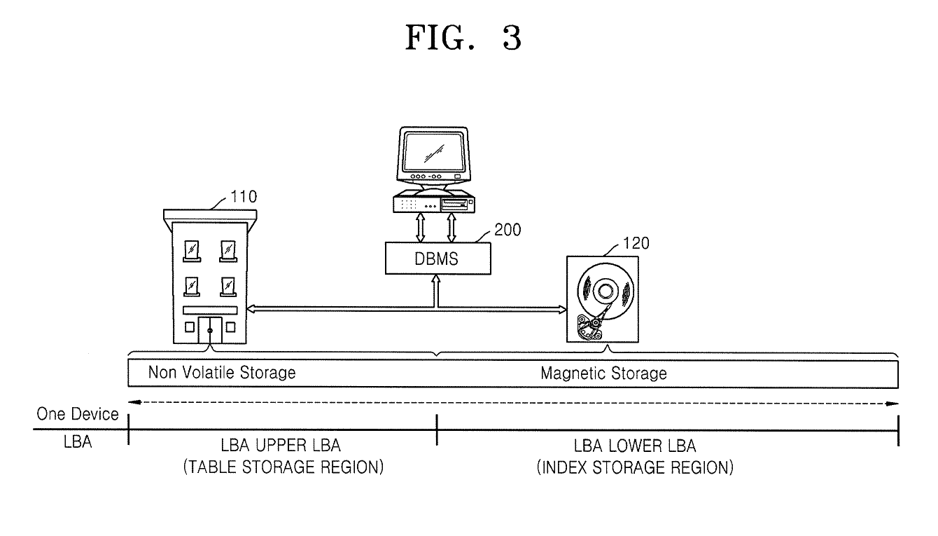

The table/index managing unit 200-1 may further integrate the SSD 110 and the HDD 120 into a virtual single storage device to allocate local block addresses (LBAs). More specifically, as illustrated in FIG. 3, the table/index managing unit 200-1 may allocate an upper LBA to the physical storage space of the SSD 110 and a lower LBA to the physical storage space of the HDD 120. Thus, a storage region of the upper LBA is allocated as a table storage region, and a storage region of the lower LBA is allocated as an index storage region.

The DBMS 200 may have a controller to receive an input from a user to control functions of the table/index managing unit 200-1, the query analyzing unit 200-2, and the query executing unit 200-3, and may further have an interface to be connected to the SSD 110 and the HDD 120 through a wired or wireless communication or a network to receive and transmit data, signal, command, etc

The SSD 110 and the HDD 120 may not be directly connected to each other, and the SSD 110 and the HDD 120 may not receive data from each other and transmit data to each other. The SSD 110 may have an interface to be connected to the DBMS 200 and the buffer 2 110-1, and the HDD 120 may have another interface to be connected to DBMS 200 and the buffer 1 120-1.

The SSD 110 and the HDD 120 may not be directly connected to each other or may not directly communicate with each other. The DBMS 200 may be directly connected to each of the SSD 110 and the HDD 120 such that the SSD 110 and the HDD 120 can transmit and receive data independently under control of DBMS 200.

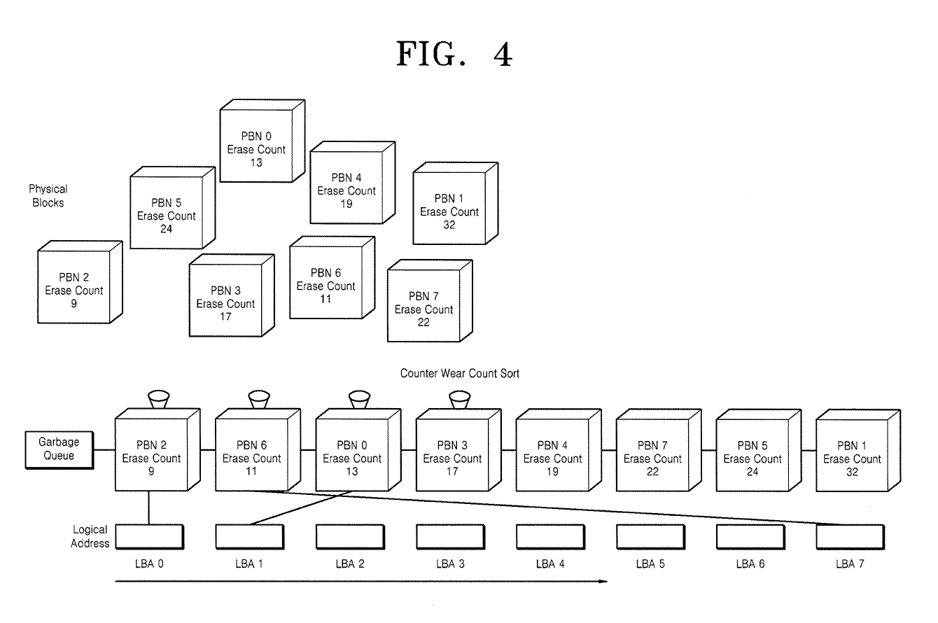

Referring to FIG. 4, LBAs may be allocated to the physical storage space of the SSD 110 by mapping all physical memory blocks to a virtual LBA after physical memory block numbers (PBNs) of the SSD 110 are classified according to a wear-count. Since the wear-count is well known, detailed descriptions thereof will be omitted.

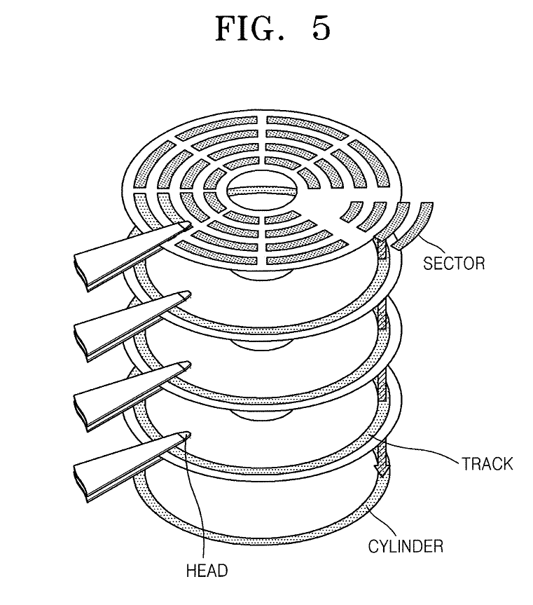

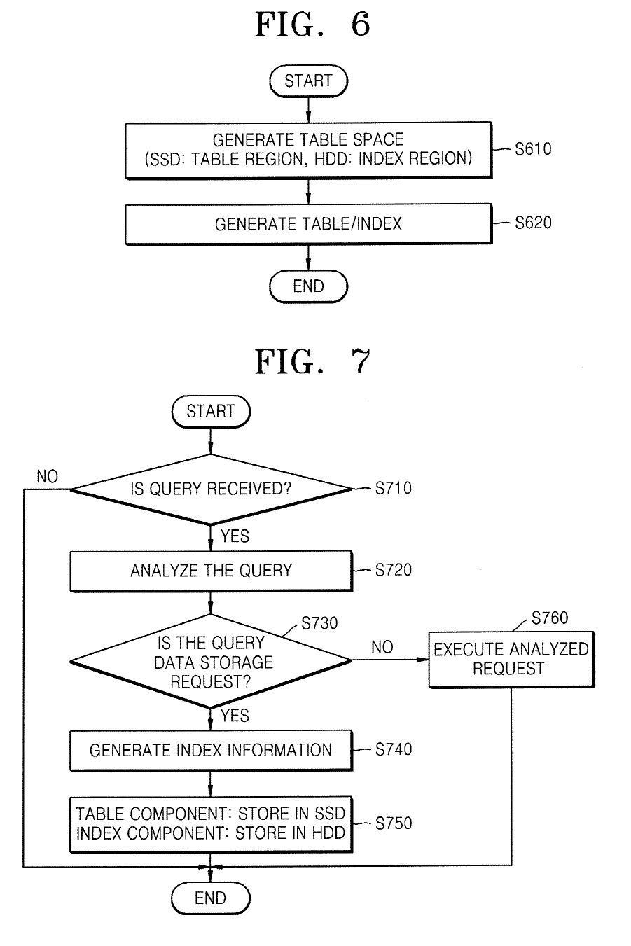

Next, the HDD 120 is mapped according to the lower LBA after a last LBA allocated to the SSD 110. That is, referring to FIG. 5, LBAs may be allocated to the physical storage space of the SSD 110 by mapping the entire storage region of the HDD 120 to the virtual LBA in a two dimensional (2D) manner in view of a sector reference. In this case, cylinder head sector (CHS) values that are three dimensional (3D) address designation methods may not be considered to allocate the LBAs to the physical storage space.

Referring back to FIG. 2, the query analyzing unit 200-2 analyzes a query received from an external server or a manager terminal and determines a request to be executed. The query executing unit 200-3 executes the query determined by the query analyzing unit 200-2.

A process of executing a data storage request will now be described.

When the query determined by the query analyzing unit 200-2 is the data storage request, the query executing unit 200-3 transmits, to the SSD 110, data to be inserted into a table and a write command used to store the data in a LBA corresponding to a row ID of a position of the table into which the data is inserted.

Then, the data to be inserted into the table is temporarily stored in a buffer 2 110-1. The NV memory controller 110-2 calculates physical block numbers (PBNs) mapped to the LBAs designated by the write command. Then, the NV memory controller 110-2 reads the data from the buffer 2 110-1 and writes the data in a storage position of the NV memory 110-3 corresponding to the PBNs calculated by the NV memory controller 110-2.

The query executing unit 200-3 generates index information that can be used to search for the data to be inserted into the table, and transmits the index information and a write command that can be used to store the index information in a LBA of the HDD 120 to the HDD 120.

Then, the index information is temporarily stored in the buffer 1 120-1. The HDD controller 120-2 calculates the CHS values corresponding to the LBAs designated by the write command, and outputs control signals for driving the HDA 120-5 to the driving unit 120-3 so as to write the index information in positions corresponding to the CHS values. The driving unit 120-3 moves a head of the HDA 120-5 onto a disk based on the control signals input from the HDD controller 120-2 to allow the head to reach a target position of the disk.

The HDD controller 120-2 sequentially reads the index information from the buffer 1 120-1 and outputs the index information to the R/W channel circuit 120-4. Then, the R/W channel circuit 120-4 processes the index information to be appropriate for a recording channel of a disk 12 and writes the processed index information onto a disk included in the HDA 120-5.

Next, a process of executing the data search request will now be described.

When the query determined by the query analyzing unit 200-2 is the data search request, the query executing unit 200-3 generates a variety of plans by using object statistics and system statistics information, selects one having the minimum costs from among the plans, and executes the data search request regarding the query.

When the query executing unit 200-3 searches for data by using an index scanning method, the query executing unit 200-3 transmits a read command, to the HDD 120, which is used to read the index information satisfying a search condition.

Then, the HDD controller 120-2 calculates the CHS values corresponding to LBAs in which the index information is stored, and outputs control signals used to drive the HDA 120-5 to the driving unit 120-3 so as to access positions corresponding to the CHS values. The driving unit 120-3 moves the head of the HDA 120-5 with respect to the disk based on the control signals input from the HDD controller 120-2 such that the head of the HDA 120-5 can reach a target position of the disk.

The RNV channel circuit 120-4 restores an electrical signal read by using the head of the HDA 120-5 from the target position of the disk included in the HDA 120-5 as the index information and temporarily stores the index information in the buffer 1 120-1. Then, the index information stored in the buffer 1 120-1 is sequentially output to the DBMS 200.

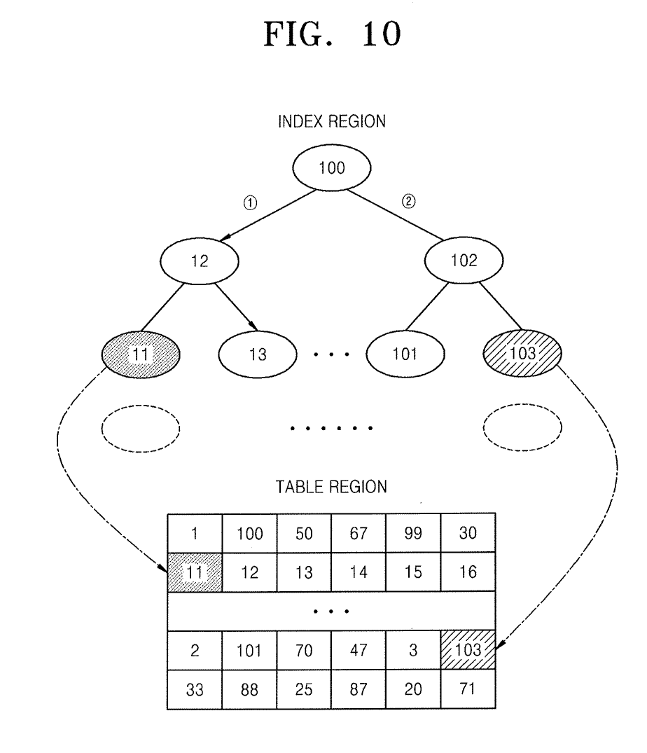

Then, the query executing unit 200-3 finds a row ID of the table by using the index information read from the HDD 120. Referring to FIG. 10, to search for 11^{th} and 103^{rd} information of a table region, the query executing unit 200-3 can find row Ds corresponding to the 11^{th} and 103^{rd} information via the paths 1 and 2 according to the index information having a tree structure.

The query executing unit 200-3 transmits a read command that can be used to read data from LBAs corresponding to the found row IDs to the SSD 110.

Then, the NV memory controller 110-2 controls calculating of PBNs mapped to the LBAs designated by the read command, reading of data stored in the storage region of the NV memory 110-3 corresponding to the PBNs, and storing of the data in the buffer 2 110-1. Then, the data stored in the buffer 2 110-1 is sequentially output to the DBMS 200. Thus, the 11^{th} and 103^{rd} information of the table region are output to the DBMS 200, thereby finding desired information.

Next, a database management method according to an exemplary embodiment of the present inventive concept will be described.

A process of generating a table space used to separate a region in which data in table form and index information used to search for the data are stored and to allocate the separated region is performed in the database 100 that is an information storage unit of a database server system at operation S610. More specifically, the data in table form and the index information are separated from each other, a storage region used to store the data in table form is allocated to a storage device having a relatively fast access speed, and a storage region used to store the index information is allocated to a storage device having a relatively slow access speed among a plurality of storage devices included in the database 100. For example, the table space is generated in such a way that the region in which the data in table form is stored is allocated to the SSD, and the region in which the index information used to search for the data is stored is allocated to the HDD 120.

Then, a process of generating a table and index in the table space is performed at operation 620. More specifically, tables designed by a database manager are stored in a physical storage space of the SSD 110, and various pieces of index information used to determine a data access sequence by using a single column or a plurality of columns of the tables are stored in a physical storage space of the HDD 120.

Methods of performing the process, for example, storing and searching for data in the database server system according to the present inventive concept will now be described.

First, the method of performing the process of storing data in the database server system will be described with reference to FIG. 7.

The database server system determines whether a query is received at operation S710. That is, the database server system determines whether the query, such as a SQL, etc., is received from an external server or a manager terminal.

If the database server system determines that the query is received, the database server system analyzes the received query at operation S720. Then, the database server system determines whether a request to be executed is a data storage request at operation S730.

If the database server system determines that the request to be executed is the data storage request, the database server system generates index information used to search for data to be inserted into a table at operation S740.

Then, the database server system stores the data to be inserted into the table in the SSD 110, and stores the index information in the HDD 120 at operation S750.

If the database server system determines that the request to be executed is not the data storage request in operation 730, the database server system performs a process corresponding to the analyzed request at operation S760.

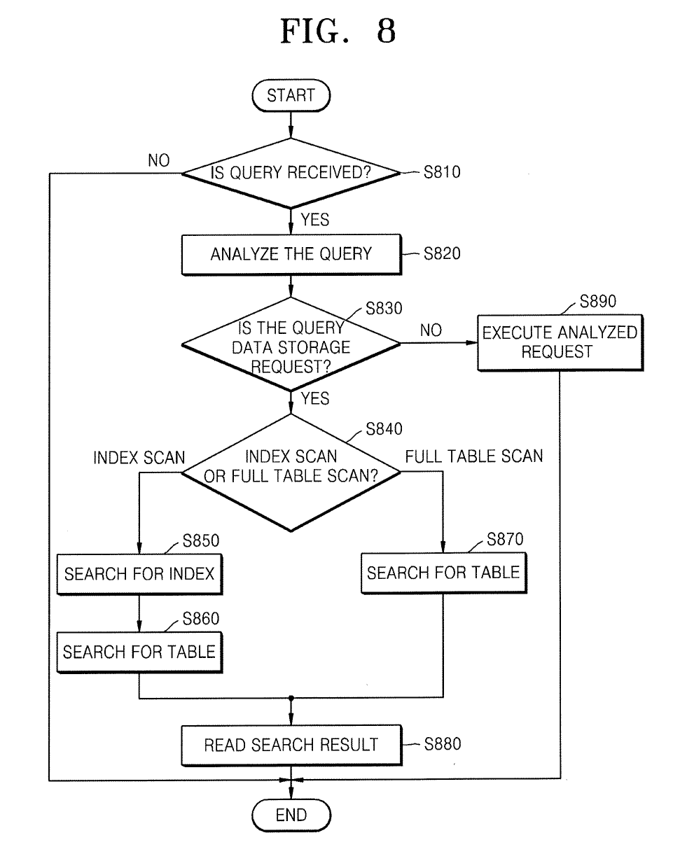

Next, the method of performing the process of searching for data in the database server system will be described with reference to FIG. 8.

The database server system determines whether a query is received at operation S810. That is, the database server system determines whether the query, such as a SQL, etc., is received from an external server or a manager terminal.

If the database server system determines that the query is received, the database server system analyzes the received query at operation S820. Then, the database server system determines whether a request to be executed is a data search request at operation S830.

If the database server system determines that the request to be executed is the data search request, the database server system determines whether to use an index scanning method or a full table scanning method at operation S840. For example, the database server system determines to use the full table scanning method when there is no index identical to the condition of the data search query or, even though there is an index similar thereto, it can be determined that it is faster to search for desired data from the entire table. In other cases, the database server system determines to use the index scanning method.

If the database server system determines to use the index scanning method in operation S840, the database server system performs an index search process at operation S850. More specifically, the database server system reads the index information from the HDD 120 according to a search condition of the query and finds a row ID of the table including desired data.

Then, the database server system searches the table by using the found row ID and reads the desired data at operation S860. More specifically, the database server system finds a row position of the table corresponding to the found row ID and reads data regarding the found row position of the table from the SSD 110.

If the database server system determines to use the full table scanning method in operation S840, the database server system searches the entire table at operation S870. More specifically, the database server system finds the desired data by searching for data from entire rows of the table selected from the SSD 110.

If the database server system determines that the request to be executed is not the data search request in operation S830, the database server system performs a process corresponding to the analyzed request at operation S890.

A result obtained by testing search times with respect to four cases of various database management methods will now be described.

Case 1 is a database management method of storing a data file and an index file in a SSD

Case 2 is a database management method of storing the data file in the SSD and the index file in the HDD

Case 3 is a database management method of storing the data file in the HDD and the index file in the SSD

Case 4 is a database management method of storing the data file and the index file in the HDD

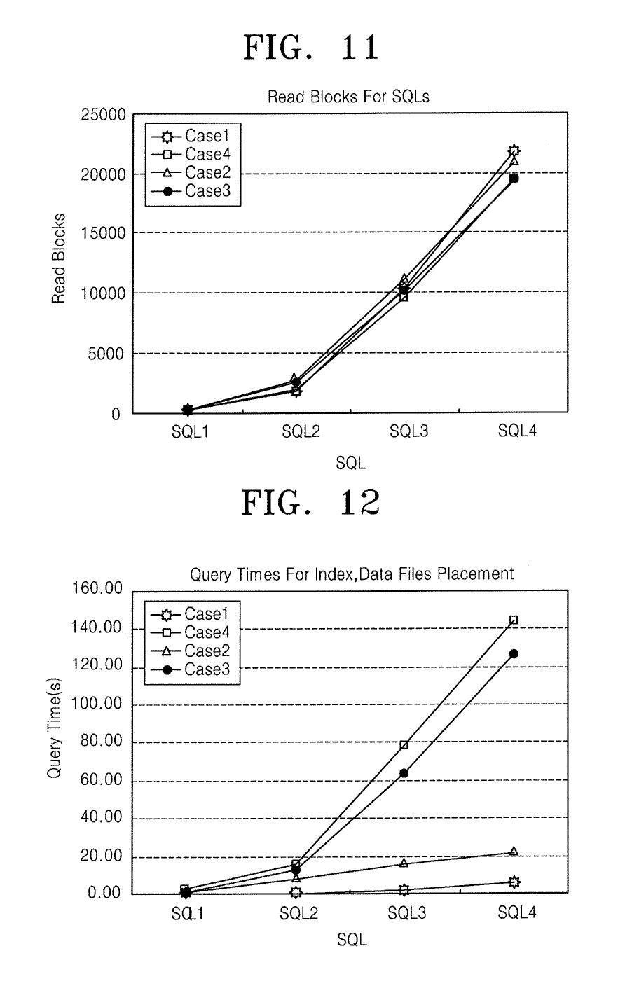

FIG. 11 is a graph of the number of blocks read according to a query, for example, the structured query language SQL1 through SQL4 of cases 1 through 4, respectively. The graph illustrates that the number of blocks read according to the same SQL has a similar distribution in cases 1 through 4.

FIG. 12 is a graph of times taken to perform the SQL1 through SQL4 of cases 1 through 4, respectively.

In comparison of times taken to perform cases 1 through 4 with respect to the same SQL, cases 1 and 2 do not show a significant difference in the times taken, whereas cases 2 and 3 show a big difference in the times taken. Cases 3 and 4 also do not show a significant difference in the times taken.

More specifically, the times taken to perform the SQL greatly differ from one another according to a storage position of the data file rather than the storage position of the index file. When the data file is disposed in the SSD, the database server system reduces the time taken to perform the SQL.

Furthermore, in comparison of an increase inclination of the times taken to perform the SQL, when the number of read blocks of the same case increases, the greater the number of the read blocks, the longer the times taken to perform the SQL in all cases 1 through 4. However, cases 1 through 4 definitely differ in the increase inclination of the times taken to perform the SQL. More specifically, when the data file is disposed in the HDD, the graph shows a big increase inclination of the times taken to perform the SQL in proportion to the increase in the number of read blocks, whereas, when the data file is disposed in the SSD, the graph shows no significant increase inclination of the times taken to perform the SQL.

If the data file is disposed in the SSD, when a great amount of data is read, the performance of the database server system greatly increases.

The graph shows that case 1 of storing the data file and the index file in the SSD is best in terms of the performance of the database server system. However, Case 1 causes an increase in the cost for building the database server system.

Meanwhile, the database management method according to the present inventive concept, such as case 2 of storing the data file in the SSD and the index file in the HDD, does not greatly differ from case 1 in terms of the performance of the database server system and reduces the cost for building the database server system.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A database management method comprising:
generating a table space in such a way that a region of a database in which data is allocated to a first storage device to store in a table form, and a region of the database in which index information is allocated to a second storage device to be used to search for the data;
storing the data in the table form in the first storage device and the index information in the second storage device according to the table space; and
storing the data in the database or searching the database according to an input query.

2. The database management method of claim 1, wherein the first storage device and the second storage device are set to have different storage methods.

3. The database management method of claim 1, wherein the first storage device is set to have a faster random access speed than that of the second storage device.

4. The database management method of claim 1, wherein the first storage device comprises a solid state drive (SSD), and the second storage device comprises a disk drive.

5. The database management method of claim 4, wherein the disk drive comprises a hard disk drive (HDD).

6. The database management method of claim 1, wherein the searching of the database comprises:
when an index scanning method is used to search for the data, finding a physical position of the first storage device in which desired data is stored by using the index information stored in the second storage device; and
reading the desired data stored in the found physical position of the first storage device.

7. The database management method of claim 6, wherein the physical position of the first storage device is found by searching for the index information stored in the second storage device that is identical to a query condition and obtaining a row ID of a table in which the desire data is positioned.

8. The database management method of claim 1, wherein the searching of the database comprises:
when a full table scanning method is used to search for the data, finding a physical position of the first storage device in which the desired data is stored by entirely searching a selected table; and
reading the desired data stored in the found physical position of the first storage device.

9. The database management method of claim 1, wherein the storing of the data in the database comprises:
generating the index information used to search for the data in the table form to be stored;
storing the data in the table form in the first storage device and the index information in the second storage device.

10. The database management method of claim 1, wherein the index information comprises information to determine a data access sequence by using a single column or a plurality of columns of the table corresponding to the table form.

11. The database management method of claim 1, wherein the first storage device and the second storage device are integrated into a virtual single storage device to allocate logic block addresses (LBAs).

12. A database server system comprising:
a database comprising a plurality of storage devices having different storage methods; and
a database management system to manage the database by which data in a table form is stored in a first storage device of the plurality of storage devices and index information used to search for the data is stored in a second storage device of the plurality of storage devices.

13. The database server system of claim 12, wherein the first storage device is set to have a faster random access speed than that of the second storage device.

14. The database server system of claim 12, wherein the first storage device comprises an SSD, and the second storage device comprises a disk drive.

15. The database server system of claim 14, wherein the disk drive comprises an HDD.

16. The database server system of claim 12, wherein the database management system comprises:
a table/index managing unit to generate a table space in such a way that a region of the database in which the data in the table form is stored is allocated to the first storage device and a region of the database in which the index information used to search for the data is stored is allocated to the second storage device, and to generate a table and an index in the table space to correspond to the data in the table form and the index information, respectively;
a query analyzing unit to analyze a received query and to determine a request to be executed according to the analyzed query; and
a query executing unit execute the request determined by the query analyzing unit.

17. The database server system of claim 12, wherein the database management system, when an index scanning method is requested to search for the data, finds a physical position of the first storage device in which desired data is stored by using the index information stored in the second storage device, and reads the desired data stored in the found physical position of the first storage device.

18. The database server system of claim 12, wherein the database management system, when a full table scanning method is requested to search for the data, finds a physical position of the first storage device in which the desired data is stored by entirely searching for a selected table, and reads the desired data stored in the found physical position of the first storage device.

19. The database server system of claim 12, wherein the first storage device and the second storage device are integrated into a virtual single storage device to allocate LBAs.

20. A database system to be connected to an external database management system, comprising:
a first storage device connected to the external database management system and having a first storage method to store data in a table form; and
a second storage device connected to the external database management system and having a second storage method different from the first storage method to store an index regarding positions of the data stored in the first storage device.

21. The database system of claim 20, wherein:
the first storage device is an SSD;
the second storage device is an HDD; and
the first storage device and the second storage device are independently operable with respect to the external database management system.

22. The database system of claim 20, wherein:
the first storage device and the second storage device are formed as a single storage device to allocate LBAs;
the first storage device is allocated with low LBAs of the LBAs and the second storage device is allocated with high LBAs of the LBAs; and
the low LBAs and the high LBAs are sequential.
